(19) United States
(12) Patent Application Publication
(10) Pub. No.: US 2007/0228032 A1
(43) Pub. Date: Oct. 4, 2007

(54) Thick-Film Fluid Heater and Continuous Heating Device

(75) Inventors: Bruno Reiter, Neresheim (DE); Martin Stickel, Giengen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/583,634

(22) PCT Filed: Dec. 22, 2004
(86) PCT No.: PCT/EP04/53667

§ 371 Date: May 14, 2007

(30) Foreign Application Priority Data
Dec. 23, 2003 (DE) 10360909.1
Dec. 17, 2004 (DE) 10 2004 060 949.7

(51) Int. Cl. H05B 3/16

(52) U.S. Cl. 219/543

(57) ABSTRACT

A thick-film fluid heater for a continuous heating device is provided and includes at least one thick-film heating element embodied in the form of an electric resistance heater, at least one heat transmission element for transmitting heat produced by the thick-film heating element to a fluid with which said element thermo-conductively communicates. Said invention is characterized in that a power control device is used for initiating a continuous or substantially continuous control of the thick-film heating element. In order to produce the continuous heating device, the thick-film fluid heater is positively assembled with a shaped piece provided with at least one input opening and at least one output opening in such a way that a fluid space is formed and the pressure and temperature resistance is ensured.

The invention relates to a thick-film fluid heater for a continuous heating device, comprising at least one thick-film heating element embodied in the form of an electric resistance heater and at least one heat transmission element which is connected in a heat-conducting manner to said thick-film heating element and the fluid so as to transfer the heat generated by the thick-film heating element to the fluid. The application further relates to a continuous heating device comprising a thick-film heating device of the aforesaid type and a household appliance with a thick-film heating element or a continuous heating device of the aforesaid type.

Heating devices and continuous heating devices of said type are used, for example in dishwashing machines or washing machines. Nowadays, heating devices based on tubular heaters are predominantly used for heating fluids. Tubular heaters usually consist of a resistance wire which is disposed centrally in a stainless steel tube so that no dielectric breakdowns can occur thereon. For precisely fixing the resistance wire in the centre of the tube and for improving the insulation, the space between the resistance wire and the stainless steel tube is filled with a insulating material, usually a magnesium oxide powder.

Tubular heaters can be used in various ways. These can be arranged in a continuous heating device through which fluid flows, for example, so that they lie in the fluid stream. In this case, the housing frequently consists of a temperature-resistant plastic. The tubular heater can be arranged on a fluid guiding tube through which fluid flows, optionally with a heat transmission element interposed. Another simple variant provides that the tubular heater is located inside a container and can be washed with the fluid.

Tubular heaters have various disadvantages. A feature common to all the variants described is that the heating device has a certain inertia as a result of the design of the tubular heater. The low powers per unit surface of the tubular heater which can be achieved, result in large component dimensions. Problems frequently also arise with the contacting of the tubular heater and other appurtenant components such as a switching element, for example, which is designed to prevent the heating device or the continuous heating device from running when dry. Finally, tubular heaters are limited in their power control since only one power stage can be achieved as a result of only one resistance wire being provided.

Furthermore, so-called “thick-film heating elements” are known as an alternative to the heating devices with tubular heaters. Known from DE 199 34 319 A1 is a heating device for fluids comprising at least one heating element embodied as an electrical resistance heater which has a heat transfer element which is in thermally conducting connection with the heating element and the fluid in order to transfer the heat generated by the heating element to the fluid. In the third embodiment, the heating device is embodied as a thick-film heater. This comprises a fluid guiding tube on the outside of which the heating element is applied in the form of a thick-film element. It is disclosed to arrange a plurality of heating elements guided around the fluid-guiding tube in a spiral configuration to achieve a plurality of power stages. Electrical contact between a plurality of these heating elements is relatively complex within the scope of the production as a result of the geometry of the fluid-guiding tube and the spiral winding of the heating elements which is why a plurality of power stages is not used in practice.

It is thus the object of the present invention to provide a thick-film heater, a continuous heating device and a household appliance which opens up the possibility of a standard construction for different countries with different mains voltages and which allows energy-saving heating of the fluid in a simple and cost-effective structure.

These objects are achieved by a heating device having the features of claim 1, by a continuous heating device having the features of claim 10, and a household appliance having the features of claims 11 to 15. Advantageous embodiments are obtained from the dependent patent claims.

According to the invention, a power control device is provided in conjunction with a thick-film heater which allows continuous or approximately continuous control of the thick-film heating element. The power control device can comprise fast-acting switching devices or elements such as a thyristor or a triac (two-way thyristor) which are controlled according to the pulse-pause modulation principle, the phase-angle principle or another principle having the same effect.

A power control device allows the thick-film heater to be used universally. For example, the same thick-film heater can be provided to achieve different power variants for different countries so that the corresponding or required power of the thick-film heating elements (for a predetermined work program) can be adjusted or controlled independently of the magnitude of the mains voltage. In addition, a continuous power or a power which can be regulated at least in small steps makes it possible to configure individual and energy-improved washing programs both when using a thick-film heater in dishwashers and in washing machines.

In order to form a closed heating system which is embodied in the form of a continuous heating device, the thick-film heating device according to the invention is connected to a moulded part in a pressure-resistant and thermally stable manner to form a fluid chamber. The moulded part has at least one inlet and at least one outlet. It is further provided to arrange the thick-film heating element outside the fluid chamber on the heat transmission element. The complete system of the continuous heating device thus consists of at least two components, namely the thick-film heater according to the invention and a moulded part connected thereto, which is also designated as a housing.

The heat transmission element which in principle can have any shape, has a preferably planar heating area on which the thick-film heating element is mounted in the form of an electrical resistance heater. This has the advantage of simple manufacture. The thick-film heating element is mounted on the heat transmission element or applied thereto. A thick-film heating element of this type usually comprises a resistance heating track which is laid (for example by printing or flame spraying) on an insulating substrate, e.g. made of glass, ceramic or a glass ceramic, which is itself provided on the heat transmission element. During the fabrication of a printed thick-film heating element, the insulating substrate is initially laid on the central area of the thick-film heating device in a sequence of printing and heating steps. The resistance heater is then applied to this layer, e.g. by film or screen printing and heated further. Fabrication is then particularly simple if the heating area on which the thick-film heater is applied, is embodied as substantially planar.

As a result of using the power control device, considerable lost energy is produced in its power range which needs to be removed. Thus, a cooling device is preferably connected to the power control device to remove this heat produced during operation of the power control device.

It is especially preferred if the cooling device is formed by the heat transmission element itself and the power control device is arranged on the heat transmission element and is connected thereto in a good heat-conducting manner. This is especially the case if the heat transmission element is embodied as flat or, formulated in general terms, matched to the shape of the heat-generating component of the power control device. The advantage of this procedure is that the lost heat is not lost but contributes to heating the fluid. As a result, the thick-film heating element can be smaller. This configuration does not prevent an additional conventional heat sink, e.g. made of aluminium, being used.

To avoid heat losses, the heat transmission element is preferably made of a material which has poor heat conduction in the lateral direction. In a direction perpendicular thereto, however, the heat transmission element exhibits good thermal conductivity whereby efficient heating of the fluid is ensured. Stainless steel can especially be considered as material for the heat transmission element.

As a result of the power control device, a plurality of heating circuits can be dispensed with. The thick-film heater according to the invention requires precisely only one heating circuit formed by the electrical connection of corresponding heating sections to achieve various power levels. This advantageously makes it possible to use only one electronic component for power control in contrast to arrangements which use a plurality of heating circuits having different power levels which must all be contacted and controlled separately. However, a plurality of heating circuits can also be power-controlled by one or a plurality of power control devices.

The preferred material for the electrical resistance heater is a material having a resistance with a positive temperature coefficient. This means that the electrical resistance heater restricts any overheating up to a certain extent if the fluid chamber runs dry or is switched-on when dry. Such a material is, for example, nickel.

It is further preferred to provide a contacting device on the heat transmission element which is electrically connected to the electrical elements of the thick-film heater. The electrical elements are on the one hand the thick-film heater and on the other hand, the power control device. The electrical connecting ends of the thick-film heater and the power control device are electrically connected to a contacting device disposed on the heat transmission element, especially in the mounting area. The thick-film heater can be thus be connected to the electrical power supply by a single plug contact and all the electrical consumers required to monitor the thick-film heater can be contacted via this contacting device. It is, for example, feasible to arrange the power control device together with the contacting device in a housing.

Further advantageous embodiments and exemplary embodiments of the thick-film heating device according to the invention and the continuous heating device according to the invention are described hereinafter. In the figures:

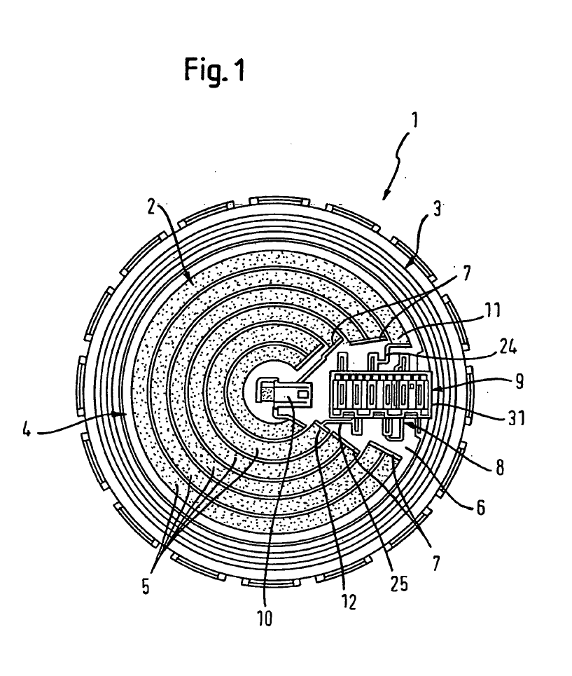

FIG. 1 is a plan view of the outer surface of a thick-film heating device according to the invention,

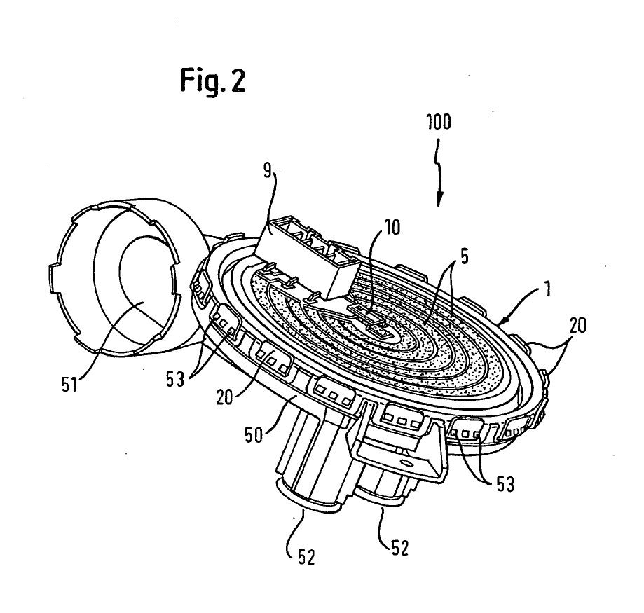

FIG. 2 is a perspective view of a continuous heating device according to the invention composed of a thick-film heating device and a moulded part.

A thick-film heating device according to the invention is described hereinafter with reference to FIGS. 1 to 4.

FIG. 1 shows a thick-film heating device 1 according to the invention in a plan view of its outer surface 14. The thick-film heating device 1 has a substantially circular shape. A thick-film heating element 2 is disposed on a heating area 4 of a heat transmission element 3, e.g. made of a stainless steel.

The thick-film heating element 2 in FIG. 1 consists, for example, of a total of seven circular concentric circular segments, each forming a heating section 5. The heating sections 5 are arranged with respect to one another so that adjacent ends of the circular segments are brought into electrical connection with one another by means of a short conductor track 7. The single heating circuit in this case thus extends from one connecting end 11 over the outermost concentric ring and each of the other concentric rings as far as a further connecting end 12. The thick-film heating element 12 is preferably configured so that it substantially completely covers the heating area. Since the thick-film heating element 12 covers the heating area of the heat transmission element 3 as completely as possible, the dimensions of the thick-film heater can be minimal. The choice of the manner in which the heating sections are shaped (straight, square, curved, concentric, spiral) is substantially dependent on the electrical power and/or the shape of the thick-film heater and especially the heat transmission element 3.

The thick-film heating element 2 of the present thick-film heating device 1 has a single heating circuit whose power output can be adjusted continuously or almost continuously by means of a power control device 31. All the heating sections 5 of the thick-film heating element 2 are serially interconnected by corresponding conductor track sections 7 in the exemplary embodiment described. The thick-film heating element 2 could alternatively consist of a single, e.g. spiral heating section. A component of this heating circuit is a fuse 10 which is located substantially at the centre of the heating area 4 in which the heating segments 5 have the smallest radii. The fuse 10 should prevent any damage to the thick-film heating element 2 in the event of the thick-film heater running dry, by connecting ends 26 of the fuse 10 melting at contact points 28 which are connected to the conductor track 7 of the heating circuit by means of solder. As a result of the small radii of the heating segments, current concentrations which promote triggering of the fuse are formed in this area. As a result of its built-in position, the separation of the contact points 28 in the event of melting of the solder can be assisted by gravity.

The heat transmission element 3 is made of metal, for example, a stainless steel which has poor thermal conductivity in the lateral direction. Perpendicular thereto, i.e. in a plane perpendicular to the plane of the drawing, however, the heat transmission element 3 exhibits good thermal conductivity so that the energy produced by the thick-film heating element is efficiently transferred to the fluid.

The power control device 31 can comprise fast-acting switching devices or elements such as a thyristor or a triac (two-way thyristor) which are controlled according to the pulse-improved modulation principle, the phase-angle principle or another principle having the same effect. By using a two-way thyristor, accurate time control can be achieved in the phase profile of a mains voltage. Alternatively, variable half/full-wave information can be switched using the pulse-pause modulation principle so that only half-waves or time-delayed full waves can be converted into power.

Operation of the power control device is accompanied by an appreciable energy loss which must be removed to avoid damage to the components of the power control device. This is usually effected by using a large-area cooling device which is in good heat-conducting communication with the power control device.

In the present invention, it is possible to dispense with such a cooling device since the function of the heat sink can be taken over by the heat transmission element 3 and the fluid flowing thereby. In order to ensure efficient heat removal, the power control device is thereby arranged directly on the heat transmission element 3, which is attached in a planar manner, with the best possible heat conduction. Any cooling device which may still be required can then be smaller-sized. The cooling area is reduced by the fraction which is effected by the heat removal with the water.

Whereas the thick-film heating element, i.e. the heating sections embodied as an electrical resistance heater, have a positive temperature coefficient, a temperature monitoring element 8 having a negative temperature coefficient can be provided in a mounting area 6. The temperature monitoring device 8, which is embodied as an NTC resistance for example, merely detects the temperature of the fluid flushing around the inner surface 13 but not the heat produced by the thick-film heating element 2 because of the properties of the heat transmission element 3. The temperature monitoring device 8 is thus decoupled from the thick-film heating element.

Despite the temperature monitoring device being decoupled from the thick-film heating element, the behaviour of the thick-film heating element 2 can be inferred since the temperature of the fluid flushing around the inner side of the heat transmission element 3 is detected and evaluated. Using an NTC resistance as a temperature monitoring device has the advantage that it is very much simpler to evaluate the delivered signal compared with a PTC resistance. In contrast to an NTC resistance, a PTC resistance requires strong temperature gradients to be able to detect a sufficient change in the resistance.

A contacting device 9 is arranged in the mounting area 6 which is left free by the thick-film heating element 2 in the heating area 4 of the heat transmission element 3. The power control device 31 can be integrated therein for example. The connecting ends 11 and 12 of the thick-film heating element 2 are electrically connected to the contacting device 9 by means of the power control device 31 and the respective conductor tracks 24 and 25. In its interior the contacting device 9 has corresponding contact tongues by which means it can be connected mechanically and electrically to a correspondingly constructed plug. The required power for heating the fluid is supplied to the thick-film heating element 2 by means of the contacting device 9 via the power control device 31.

The temperature monitoring device is located in the immediate proximity of the contacting device 9 and is electrically connected thereto. All the electrical consumers provided in the thick-film heating device can thereby be contacted by means of a single plug contact by means of the contacting device.

As an example, FIG. 2 shows a perspective view of a continuous heating device 100 according to the invention, showing the thick-film heating device 1 with a moulded part 50 associated therewith. The moulded part 50, which consists of a plastic, for example, has a radially oriented inlet 51. Two axially extending outlets 52 are furthermore provided. Each of the outlets 52 can be connected to a separate spray device of a dishwashing machine. The arrangement of the inlets and outlets can naturally also be made at positions differing from those shown in the figure.

In the thick-film heater according to the invention, the thickness of the heat transmission element 3 can be reduced compared with using a tubular heater so that the heat transfer therethrough to the fluid is improved. This has the advantage that the temperature of the electrical resistance heater can be reduced since the heat is led away more efficiently therefrom to the fluid. The reduction of the temperature of the electrical resistance heater allows the power density of the thick-film heater to be increased and thus its size to be reduced at a given maximum permissible temperature.

The connection between the thick-film heating device 1 and the moulded part 50 by means of a locating means can be seen from the perspective view in FIG. 2. The engagement is made by means of lugs 20 which engage in locating hooks 53 and which prevent the moulded part 50 from becoming detached from the thick-film heating device 1 even under pressure. It cannot be seen from the diagram that a sealing ring is disposed between the moulded part 50 and the thick-film heating device 1. More precisely, the sealing ring is disposed between a wall of the moulded part extending into the channel 16 and the inner channel wall 18, thereby ensuring good tightness even under pressure, i.e. under possible deformation, especially of the moulded part but also of the thick-film heating device.

The fluid chamber formed in the interior between the thick-film heating device and the moulded part has no flow resistances such as is the case in tubular heaters, for example located inside a fluid chamber. For this reason, in a continuous heating device according to the invention, the pumping capacity can be reduced since fewer flow losses need to be compensated. Costs can be saved with a smaller pump. On the other hand, higher pressures can be achieved with the pumps used hitherto so that the mechanical action upon items to be washed is increased.

The continuous heating device according to the invention has a very small number of parts overall and can be produced particularly simply. The use of a power control device allows continuous or almost continuous control of the thick-film heating element and therefore of the amount of heat which it produces, independently of the mains voltage used. At the same time, no complex arrangement of the thick-film heating element are required since the power control device makes it possible to have a design with only one heating circuit. In addition, the electrical contact of the continuous heating device according to the invention is simplified substantially since only one electronic component is required to control the thick-film heating element.

### Reference List

1 Thick-film heating device

2 Thick-film heating element

3 Heat transmission element

4 Heating area

5 Heating section

6 Mounting area

7 Conductor track

8 Temperature monitoring device

9 Contacting device

10 Fuse

11 Connecting end

12 Connecting end

20 Lug

24 Conductor track

25 Conductor track

31 Power control device

50 Moulded part

51 Inlet

52 Outlet

53 Locating hook

100 Continuous heating device

1-15. (canceled)

16. A thick-film heating device for fluids for mounting in a continuous heating device, comprising at least one thick-film heating element embodied as an electric resistance heater and at least one heat transmission element which is connected in a heat-conducting manner to the thick-film heating element and the fluid so as to transfer the heat generated by the thick-film heating element to the fluid, characterized in that a power control device is provided for initiating a continuous or almost continuous control of the thick-film heating element.

17. The thick-film heating device according to claim 16, wherein the power control can be carried out by means of phase-angle or pulse pause modulation.

18. The thick-film heating device according to claim 16, wherein the power control device is a thyristor or a triac.

19. The thick-film heating device according to claim 16, wherein a cooling device is coupled to the power control device to remove the heat produced during operation of the power control device.

20. The thick-film heating device according to claim 16, wherein the cooling device is formed by the heat transmission element and the power control device is arranged on the heat transmission element and is connected thereto in a good heat-conducting manner.

21. The thick-film heating device according to claim 16, wherein the heat transmission element is made of a material which has a poor thermal conductivity in the lateral direction, e.g. stainless steel.

22. The thick-film heating device according to claim 16, wherein the thick-film heating element has precisely one heating circuit through electrical connection of corresponding heating section.

23. The thick-film heating device according to claim 16, wherein the thick-film heating element is formed from a material having a positive temperature characteristic (PTC).

24. The thick-film heating device according to claim 16, wherein there is provided a contacting device disposed on the heat transmission element which is electrically connected to the electrical elements of the thick-film heating device.

25. A continuous heating device comprising a thick-film heating device and a moulded part connected positively thereto in a pressure-resistant and thermally stable manner to form a fluid chamber, wherein the moulded part has at least one inlet and at least one outlet.

26. A household appliance, especially a dishwasher or a washing machine, including an item handling means for handling items and a thick-film heater for supplying heat relative to the items being handled, the thick-film heater for mounting in a continuous heating device and including at least one thick-film heating element embodied as an electric resistance heater and at least one heat transmission element which is connected in a heat-conducting manner to the thick-film heating element and the fluid so as to transfer the heat generated by the thick-film heating element to the fluid, characterized in that a power control device is provided for initiating a continuous or almost continuous control of the thick-film heating element.

27. The household appliance according to claim 26 and further comprising a continuous heating device disposed in the household appliance.

28. The household appliance according to claim 26 and further comprising a cooling device coupled to the power control device to remove heat produced during operation of the power control device.

29. The household appliance according to claim 28, wherein the cooling device is formed by the heat transmission element and the power control device is arranged on the heat transmission element and is connected thereto in a heat-conducting manner.

30. The household appliance according to claim 29, wherein the power control can be carried out by means of phase-angle or pulse pause modulation and the power control device is a thyristor or a triac.
